(19) United States
(12) Patent Application Publication
(10) Pub. No.: US 2024/0224259 A1
(43) Pub. Date: Jul. 4, 2024

(54) ACCESS POINT-TO-ACCESS POINT TRANSMISSION OPPORTUNITY SHARING

(71) Applicant: QUALCOMM Incorporated, San Diego, CA (US)

(72) Inventors: Yanjun Sun, San Diego, CA (US); Abhishek Pramod Patil, San Diego, CA (US); Alfred Asterjadhi, San Diego, CA (US); Sai Yiu Duncan Ho, San Diego, CA (US); George Cherian, San Diego, CA (US); Abdel Karim Ajami, Lakeside, CA (US); Gaurang Naik, San Diego, CA (US)

(21) Appl. No.: 18/149,629

(22) Filed: Jan. 3, 2023

(51) Int. Cl. H04W 72/1263; H04W 72/27

(52) U.S. Cl. CPC H04W 72/1263; H04W 72/27

(57) ABSTRACT

Methods, systems, and devices for wireless communications are described. An access point (AP) may support sharing a portion of a transmission opportunity (TXOP) with another AP using an AP-specific AID. For example, a first AP may obtain a TXOP associated with communication via a wireless channel. The first AP may determine to allocate a portion of the TXOP to a second AP. To allocate the portion of the TXOP to the second AP, the first AP may transmit a frame that indicates one or more resources of the TXOP that are allocated to an AP identified by the frame. To identify the second AP, the frame may include an AP-specific AID selected by or otherwise assigned to the second AP. The second AP may communicate one or more frames during the portion of the TXOP allocated to the second AP.

### TECHNICAL FIELD

This disclosure relates generally to wireless communication, and more specifically, to access point (AP)-to-AP transmission opportunity (TXOP) sharing.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, an AP may obtain a transmission opportunity (TXOP), such as via contention-based procedures, and may communicate one or more frames during the TXOP with one or more other devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a first access point (AP). The first AP includes at least one memory and at least one processor communicatively coupled with the at least one memory. The at least one processor is operable to cause the first AP to obtain a transmission opportunity (TXOP) associated with communication via a wireless channel, transmit a frame including an association identifier (AID) associated with a second AP, the frame allocating a portion of the TXOP to the second AP for communicating via the wireless channel based on the AID associated with the second AP, and receive, based on transmitting the frame, a confirmation of the allocation of the portion of the TXOP to the second AP.

Another innovative aspect of the subject matter described in this disclosure can be implemented in a method for wireless communication. The method includes obtaining, at a first AP. a TXOP associated with communication via a wireless channel, transmitting a frame including an AID associated with a second AP, the frame allocating a portion of the TXOP to the second AP for communicating via the wireless channel based on the AID associated with the second AP, and receiving, based on transmitting the frame, a confirmation of the allocation of the portion of the TXOP to the second AP.

In some examples, the method and first AP may further include operations, features, means, or instructions for receiving, via a backhaul link associated with a network controller that is associated with the first AP and the second AP, an indication that the AID is assigned to the second AP, where transmitting the frame may include operations, features, means, or instructions for transmitting the frame based on the indication.

In some examples, the method and first AP may further include operations, features, means, or instructions for selecting the AID associated with the second AP from a set of AIDs specific to APs and transmitting, based on the selecting, an indication that the AID is assigned to the second AP, where transmitting the frame may include operations, features, means, or instructions for transmitting the frame based on the indication.

In some examples, the method and first AP may further include operations, features, means, or instructions for receiving, via a communication link between the first AP and the second AP, a first indication that the AID is associated with the second AP, where transmitting the frame may include operations, features, means, or instructions for transmitting the frame based on the first indication.

In some examples, the method and first AP may further include operations, features, means, or instructions for receiving, via a communication link between the first AP and the second AP, a first indication of a second AID associated with the second AP, transmitting, via the communication link, a second indication that the second AID associated with the second AP matches an AID associated with a third AP, and receiving, via the communication link based on the second indication, a third indication of the AID associated with the second AP.

In some examples, the method and first AP may further include operations, features, means, or instructions for transmitting a second frame, the second frame being associated with triggering the second AP to request the allocation of the portion of the transmission opportunity and receiving a response frame indicating that the second AP requests the allocation of the portion of the transmission opportunity, where transmitting the frame may include operations, features, means, or instructions for transmitting the frame based at least in part on the response frame.

Another innovative aspect of the subject matter described in this disclosure can be implemented in a second AP. The second AP includes at least one memory and at least one processor communicatively coupled with the at least one memory. The at least one processor is operable to cause the second AP to receive a frame from a first AP, the frame including an AID associated with the second AP, the frame allocating a portion of a TXOP associated with communication via a wireless channel obtained by the first AP to the second AP based on the AID of the second AP, transmit, based on receiving the frame, a confirmation of the allocation of the portion of the TXOP to the second AP, and transmit, based on the allocation of the portion of the TXOP to the second AP, one or more frames during the portion of the TXOP.

Another innovative aspect of the subject matter described in this disclosure can be implemented in a method for wireless communication. The method includes receiving a frame from a first AP at a second AP, the frame including an AID associated with the second AP, the frame allocating a portion of a TXOP associated with communication via a wireless channel obtained by the first AP to the second AP based at least in part on the AID of the second AP, transmitting, based on receiving the frame, a confirmation of the allocation of the portion of the TXOP to the second AP, and transmitting, based on the allocation of the portion of the TXOP to the second AP, one or more frames during the portion of the TXOP.

In some examples, the method and second AP may further include operations, features, means, or instructions for receiving, via a backhaul link associated with a network controller that may be associated with the first AP and the second AP, an indication that the AID is assigned to the second AP, where receiving the frame may include operations, features, means, or instructions for receiving the frame based on the indication.

In some examples, the method and second AP may further include operations, features, means, or instructions for receiving, via a communication link between the first AP and the second AP, an indication that the AID is assigned to the second AP, where receiving the frame may include operations, features, means, or instructions for receiving the frame based on the indication.

In some examples, the method and second AP may further include operations, features, means, or instructions for selecting the AID associated with the second AP from a set of AIDs specific to APs and transmitting, based on the selecting, an indication of the AID associated with the second AP to the first AP, where receiving the frame may include operations, features, means, or instructions for receiving the frame based on the indication.

In some examples, the method and second AP may further include operations, features, means, or instructions for transmitting, via a communication link between the first AP and the second AP, a first indication of a second AID associated with the second AP to the first AP, receiving, via the communication link, a second indication that the second AID associated with the second AP matches an AID associated with a third AP, selecting, based on the second indication, the AID for association with the second AP, and transmitting, via the communication link based on the selecting, a third indication of the AID associated with the second AP.

In some examples, the method and second AP may further include operations, features, means, or instructions for receiving a second frame, the second frame being associated with triggering the second AP to request the allocation of the portion of the TXOP and transmitting a response frame indicating that the second AP requests the allocation of the portion of the TXOP, where receiving the frame may include operations, features, means, or instructions for receiving the frame based at least in part on the response frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) PDU (PPDU) usable for communications between a wireless AP and one or more wireless STAs.

FIG. 4 shows an example of a wireless communication network that supports AP-to-AP transmission opportunity (TXOP) sharing in accordance with one or more aspects of the present disclosure.

FIG. 5 shows an example of a communication sequence that supports AP-to-AP TXOP sharing in accordance with one or more aspects of the present disclosure.

FIG. 6 shows an example of a frame field diagram that supports AP-to-AP TXOP sharing in accordance with one or more aspects of the present disclosure.

FIG. 7 shows an example of a communication sequence that supports AP-to-AP TXOP sharing in accordance with one or more aspects of the present disclosure.

FIGS. 8 and 9 show flowcharts illustrating example processes performable by a wireless AP that supports AP-to-AP TXOP sharing in accordance with one or more aspects of the present disclosure.

FIG. 10 shows a block diagram of an example wireless communication device that supports AP-to-AP TXOP sharing in accordance with one or more aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In some cases, an access point (AP) may share a transmission opportunity (TXOP) with another AP. The AP may leverage association identifiers (AIDs) that are unused in identifying non-AP stations (STAs) to signal the allocation of a portion of a TXOP from the AP to the other AP.

For example, a first AP may obtain a TXOP (such as a contention-based TXOP) associated with a wireless channel that corresponds to a duration of time during which the first AP may transmit frames via the wireless channel. In some examples, the first AP, which may be referred to as a TXOP sharing AP or sharing AP, may allocate a portion of the TXOP to a non-AP STA (such as within a basic service set (BSS) managed by the first AP), for example, by including an association identifier (AID) of the non-AP STA in a frame that allocates the portion of the TXOP to the identified non-AP STA (such as a multi-user request to send (MU-RTS) TXOP sharing (TXS) frame). To support allocating the portion of the TXOP to a second AP, which may be referred to as a shared AP, the first AP may include an AID associated with the second AP in a frame that allocates the portion of the TXOP to a device corresponding to the AID. For example, various subsets of AIDs may be reserved or otherwise unused to identify a non-AP STA. One or more of the subsets of AIDs may be allocated for identification of APs in association with TXOP sharing. An AID of the one or more subsets of AIDs may be selected by or otherwise assigned to the second AP such that the first AP may transmit the frame that includes the AID associated with the second AP to allocate the portion of the TXOP to the second AP.

Particular aspects of the subject matter described in this disclosure can be implemented to realize one or more of the following potential advantages. Inter-AP TXOP sharing may increase coordination between devices, increase resource utilization efficiency, and reduce latency, among other benefits. For example, inter-AP TXOP sharing may facilitate APs to coordinate with each other such that higher priority traffic may be communicated earlier by allocating portions of TXOPs to APs to communicate the higher priority traffic instead of waiting for the respective APs to win contention for a TXOP to be able to communicate the traffic. Additionally, with appropriate selection of the shared APs and the scheduling of their respective time or frequency resources, TXOP sharing may support increased medium utilization and efficiency. Additionally, by allocating AIDs for AP identification in association with TXOP sharing, TXOP sharing may be extended to be between APs using existing frame structures. For example, frames used in TXOP sharing with non-AP STAs may be used for inter-AP TXOP sharing despite other AP identifiers being too long to be included in the TXOP sharing frames, for example, by using AP-specific AIDs to identify the APs instead.

Aspects of the disclosure are initially described in the context of wireless communication networks, a protocol data unit (PDU), and a physical layer (PHY) PDU (PPDU). Aspects of the disclosure are additionally described in the context of communication sequences and a field diagram. Aspects of the disclosure are further illustrated by and described with reference to flowcharts, and an apparatus diagram that relate to AP-to-AP TXOP sharing.

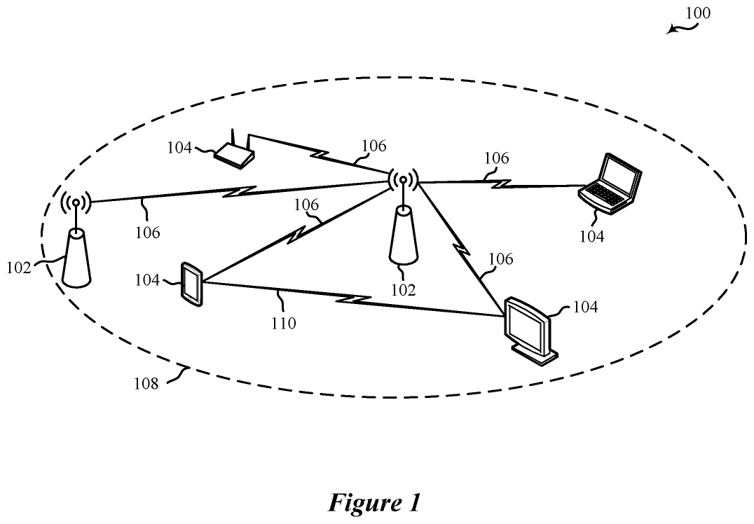

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. The WLAN 100 can include multiple APs 102. An AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a BSS identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (us)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an AID to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHZ or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUS) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective AIDs. and may assign each AID (and thus each STA 104) one or more RUs that can be used to send UL traffic to the AP 102. The AP 102 also may designate one or more random access (RA) RUs that unscheduled STAs 104 may contend for.

Some APs 102 and STAs 104 may implement spatial reuse techniques. For example, APs 102 and STAs 104 configured for communications using IEEE 802.11ax or 802.11be may be configured with a BSS color. APs 102 associated with different BSSs may be associated with different BSS colors. A BSS color is a numerical identifier of an AP's respective BSS (such as a 6 bit field carried by the SIG field). Each STA 104 may learn its own BSS color upon association with the respective AP. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA, the AP 102 or STA 104 may use a first received signal strength indication (RSSI) detection threshold when performing a CCA on the wireless channel. However, if the BSS color associated with the wireless packet is different than the BSS color of the AP 102 or STA, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs 102 and STAs 104 may implement techniques for spatial reuse that involve participation in a coordinated communication scheme. According to such techniques, an AP 102 may contend for access to a wireless medium to obtain control of the medium for a TXOP. The AP 102 that wins the contention (hereinafter also referred to as a “sharing AP”) may select one or more other APs 102 (hereinafter also referred to as “shared APs”) to share resources of the TXOP. The sharing and shared APs 102 may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP. The sharing AP 102 may allocate the time or frequency segments to itself or to one or more of the shared APs 102. For example, each shared AP 102 may utilize a partial TXOP assigned by the sharing AP 102 for its uplink or downlink communications with its associated STAs 104.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs 102 and their respective BSSs, subject to appropriate power control and link adaptation. For example, the sharing AP 102 may limit the transmit powers of the selected shared APs 102 such that interference from the selected APs 102 does not prevent STAs 104 associated with the TXOP owner from successfully decoding packets transmitted by the sharing AP. Such techniques may be used to reduce latency because the other APs 102 may not need to wait to win contention for a TXOP to be able to transmit and receive data according to conventional CSMA/CA or EDCA techniques. Additionally, by enabling a group of APs 102 associated with different BSSs to participate in a coordinated AP transmission session, during which the group of APs 102 may share at least a portion of a single TXOP obtained by any one of the participating APs, such techniques may increase throughput across the BSSs associated with the participating APs 102 and may also achieve improvements in throughput fairness. Furthermore, with appropriate selection of the shared APs 102 and the scheduling of their respective time or frequency resources, medium utilization may be maximized or otherwise increased while packet loss resulting from OBSS interference is minimized or otherwise reduced. Various implementations may achieve these and other advantages without requiring that the sharing AP 102 or the shared APs 102 be aware of the STAs 104 associated with other BSSs, without requiring a preassigned or dedicated master AP 102 or preassigned groups of APs 102, and without requiring backhaul coordination between the APs 102 participating in the TXOP.

In some examples in which the signal strengths or levels of interference associated with the selected APs 102 are relatively low (such as less than a given value), or when the decoding error rates of the selected APs 102 are relatively low (such as less than a threshold), the start times of the communications among the different BSSs may be synchronous. Conversely, when the signal strengths or levels of interference associated with the selected APs 102 are relatively high (such as greater than the given value), or when the decoding error rates of the selected APs 102 are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP 102 (or its associated STAs) to decode the preamble of the wireless packet and obtain the BSS color value carried in the wireless packet to determine whether the wireless packet is an intra-BSS packet or an OBSS packet. In this manner, each of the participating APs 102 and their associated STAs 104 may be able to receive and decode intra-BSS packets in the presence of OBSS interference.

In some examples, the sharing AP 102 may perform polling of a set of un-managed or non-co-managed APs 102 that support coordinated reuse to identify candidates for future spatial reuse opportunities. For example, the sharing AP 102 may transmit one or more spatial reuse poll frames as part of determining one or more spatial reuse criteria and selecting one or more other APs 102 to be shared APs 102. According to the polling, the sharing AP 102 may receive responses from one or more of the polled APs 102. In some specific examples, the sharing AP 102 may transmit a coordinated AP TXOP indication (CTI) frame to other APs 102 that indicates time and frequency of resources of the TXOP that can be shared. The sharing AP 102 may select one or more candidate APs 102 upon receiving a coordinated AP TXOP request (CTR) frame from a respective candidate AP 102 that indicates a desire by the respective AP 102 to participate in the TXOP. The poll responses or CTR frames may include a power indication, for example, an RX power or RSSI measured by the respective AP. In some other examples, the sharing AP 102 may directly measure potential interference of a service supported (such as UL transmission) at one or more APs, and select the shared APs 102 based on the measured potential interference. The sharing AP 102 generally selects the APs 102 to participate in coordinated spatial reuse such that it still protects its own transmissions (which may be referred to as primary transmissions) to and from the STAs 104 in its BSS. The selected APs 102 may then be allocated resources during the TXOP as described above.

In accordance with examples described herein, a sharing AP 102 may utilize an AP-specific AID to identify a shared AP 102 to which resources of a TXOP are allocated. For example, various subsets of AIDs may be reserved from being used to or may be otherwise unused to identify a STA 104 (such as non-AP STAs 104). For instance, some AIDs may be reserved for purposes other than identification of a STA 104 (or allocation of RUs). Additionally, some AIDs may be used for the identification of a STA in some communication scenarios, while being excluded from being used for the identification of a STA 104 in other communication scenarios (such as in association with the communication of a high efficiency (HE) MU PPDU or an EHT MU PPDU, among others). One or more of the subsets of AIDs may be allocated for identification of APs 102 in association with TXOP sharing. For example, an AID of the one or more subsets of AIDs may be selected by or otherwise assigned to the shared AP 102 such that the sharing AP 102 may transmit a frame (such as a CTI, an MU-RTS frame, or an MU-RTS TXS frame, among others) that includes the AID associated with the shared AP 102 to allocate the portion of the TXOP to the shared AP 102. In this way, an AID subfield of the frame, which may otherwise be used to identify non-AP STAs for TXOP sharing, may be leveraged to identify and indicate the shared AP 102 to which the portion of the TXOP is allocated.

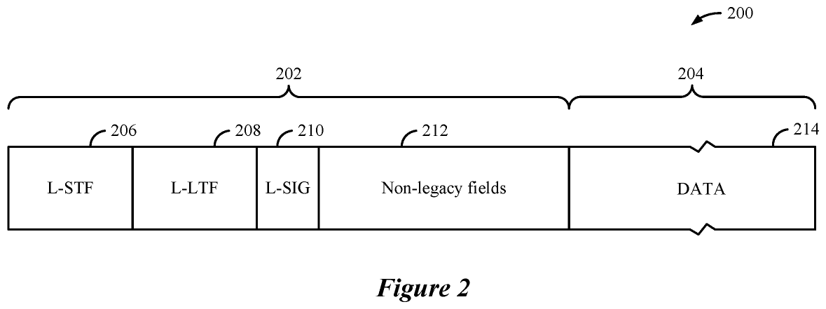

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some examples, TXOPs may be shared between APs 102 such that coordination of and latency associated with communicating a PDU 200 may be improved. For example, a sharing AP 102 may utilize an AP-specific AID associated with a shared AP 102 to allocate a portion of a TXOP obtained by the sharing AP 102 to the shared AP 102. The shared AP 102 may communicate one or more PDUs 200 during the allocated portion of the TXOP, for example, with one or more STAs 104 that are a part of a BSS associated with (such as managed by) the shared AP 102, the sharing AP 102, one or more other APs 102, or any combination thereof. As such, a latency associated with communicating the one or more PDUs 200 may be reduced as the shared AP 102 may communicate the one or more PDUs 200 during the portion of the TXOP rather than waiting to obtain a TXOP of its own.

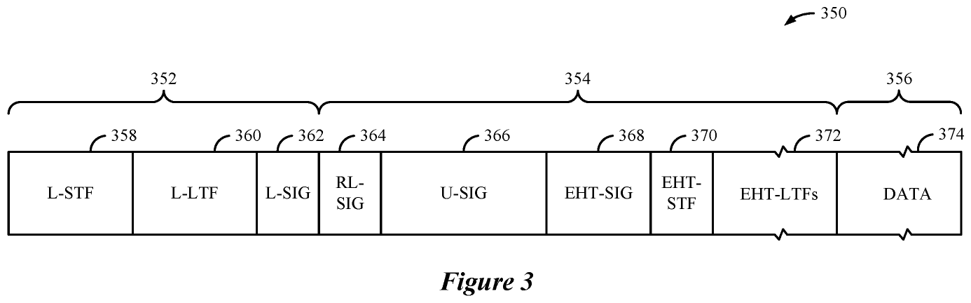

FIG. 3 shows another example PPDU 350 usable for wireless communication between a wireless AP and one or more wireless STAs. The PPDU 350 may be used for SU, OFDMA or MU-MIMO transmissions. The PPDU 350 may be formatted as an Extremely High Throughput (EHT) WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU 350 includes a PHY preamble including a legacy portion 352 and a non-legacy portion 354. The PPDU 350 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled UL or DL resources for them. EHT-SIG 368 may be decoded by each compatible STA 104 served by the AP 102. EHT-SIG 368 may generally be used by a receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some examples, TXOPs may be shared between APs 102 such that coordination of and latency associated with communicating a PPDU 350 may be improved. For example, a sharing AP 102 may utilize an AP-specific AID associated with a shared AP 102 to allocate a portion of a TXOP obtained by the sharing AP 102 to the shared AP 102. The shared AP 102 may communicate one or more PPDUs 350 during the allocated portion of the TXOP, for example, with one or more STAs 104 that are a part of a BSS associated with the shared AP 102, the sharing AP 102, one or more other APs 102, or any combination thereof. As such, a latency associated with communicating the one or more PPDUs 350 may be reduced as the shared AP 102 may communicate the one or more PPDUs 350 during the portion of the TXOP rather than waiting to obtain a TXOP of its own.

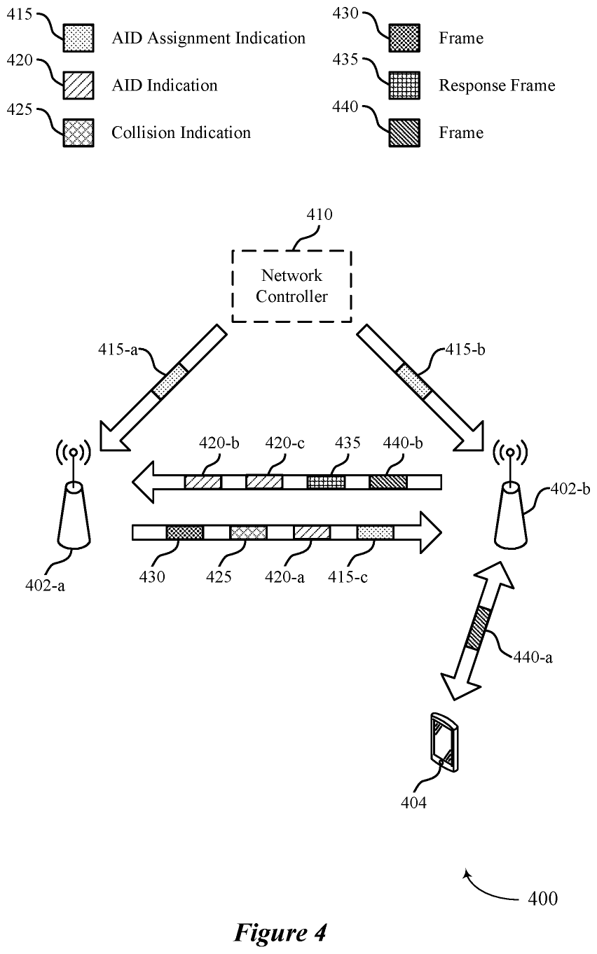

FIG. 4 shows an example of a wireless communication network 400 that supports AP-to-AP TXOP sharing in accordance with one or more aspects of the present disclosure. The wireless communication network 400 may implement or be implemented by aspects of the wireless communication network 100. For example, the wireless communication network 400 may include APs 402 and one or more STAs 404, which may be examples of the corresponding devices described herein, including with reference to FIGS. 1 through 3.

The wireless communication network may support the use of AP-specific AIDs to facilitate the sharing of TXOPs between APs 402. For example, the wireless communication network 400 may include an AP 402-a and an AP 402-b. The AP 402-a may obtain a TXOP associated with communication via a wireless channel (such as a contention-based TXOP). For example, the AP 402-a may contend for access to the wireless channel (such as a wireless medium shared by the APs 402, among other devices) to obtain control of the wireless channel for a TXOP. The TXOP may correspond to a duration of time during which the AP 402-a may (in some cases, exclusively) communicate (such as transmit or receive) one or more frames using one or more frequency resources.

The AP 402-a may determine to share (such as allocate or assign) one or more portions of the TXOP with one or more other APs 402 with which the AP 402-a may communicate. In the example of FIG. 4, the AP 402-a may determine to allocate a portion of the TXOP to the AP 402-b so that the AP 402-b may communicate via the wireless channel during (such as via) the portion of the TXOP. For example, the AP 402-a may allocate time and/or frequency resources to the AP 402-b associated with the TXOP that the AP 402-b may use to communicate one or more frames 440.

To allocate the portion of the TXOP to the AP 402-b, the AP 402-a may transmit a frame 430 to the AP 402-b. For example, the frame 430 may be a frame that allocates an indicated portion of a TXOP to an indicated device. For instance, the frame 430 may include one or more fields that indicate (such as specify) resources of the TXOP allocated by the frame 430 and indicate the device to which the resources of the TXOP are allocated. In some examples, the frame 430 may be a trigger frame, such as an MU-RTS frame, an MU-RTS TXS frame, or some other type of trigger frame. In some examples, the frame 430 may be a report poll frame, such as a buffer status report poll (BSRP) frame or a null data PHY PDU feedback report poll (NFRP) frame, among other types of report poll frames. In some examples, the frame 430 may be any type of control frame or management frame that indicates the allocated portion of the TXOP and the AP 402 to which the portion of the TXOP is allocated.

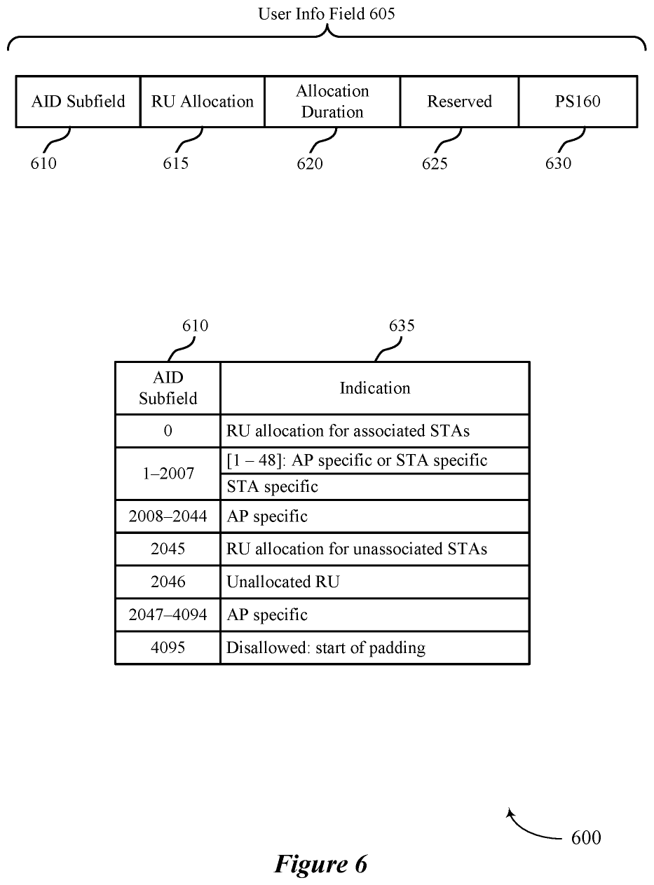

To indicate the AP 402 to which the portion of the TXOP is allocated, the frame 430 may include an AP-specific AID. For example, the frame 430 may include an AID subfield (such as an AID12 subfield of a user info field) that indicates the device to which the portion of the TXOP is allocated. In some cases, various subsets of the possible AIDs that may be indicated via the AID subfield may be used (such as reserved) for identifying (such as indicating) an associated STA 404 (such as a non-AP STA). Other subsets of the possible AIDs may be unused to identify a STA 404, e.g., certain AIDs may be reserved from being used for such identification of a STA 404 or certain AIDs that are used for identification of STA 404 in some communication scenarios may be unused for such identification in other communication scenarios (such as in association with the communication of a high efficiency (HE) MU PPDU or an EHT MU PPDU, among others). An example of such division between subsets of possible AIDs is described with reference to FIG. 6. One or more of the subsets of the reserved or otherwise unused AIDs may be configured (such as allocated, defined) for identification of APs 402 in association with TXOP sharing and may be referred to as AP-specific AIDs. For example, an AP-specific AID may be selected by or otherwise assigned to the AP 402-b such that the AP 402-a may transmit the frame 430 including the AID associated with the AP 402-b to allocate the portion of the TXOP to the AP 402-b. In some examples, APs 402 may be prohibited from being assigned or selecting a STA-specific AID, and STAs 404 may be likewise prohibited from being assigned or selected an AP-specific AID, for example, to avoid AID collision (such as selection or assignment of a same AID to multiple devices) between an AP 402 and a STA 404.

In some examples, allocation (such as selection or assignment) of AP-specific AIDs to respective APs 402 may be based on a type of the wireless communication network 400. For example, the wireless communication network 400 may be an example of a centralized network in which a network controller 410 manages operation of the network, for example, via backhaul links via which the network controller 410 may communicate with one or more APs 402 in the network. For instance, the wireless communication network 400 may include the network controller 410 that may communicate with the AP 402-a and the AP 402-b via respective backhaul links. Examples of a centralized network include an enterprise network and a mesh network, such as a Wi-Fi Alliance EasyMesh network, among other types of centralized networks. In some examples, the network controller 410 may be implemented at a root AP 402 of the network (such as an AP 402 that directly communicates with a core network or network provider). For example, the AP 402-a may be an AP 402 that implements the network controller 410 and manages operation of the wireless communication network 400. In some examples, if the AP 402-a is the root AP 402, the AP 402-b may be an example of range extender that operates to extend a communication range of the AP 402-a.

If the wireless communication network 400 is a centralized network, the network controller 410 (such as the AP 402-a) may assign AP-specific AIDs to respective APs 402. For example, the network controller 410 may select a first AID from a set of AP-specific AIDs and transmit an AID assignment indication 415-a to the AP 402-a indicating that the first AID is assigned to the AP 402-a. The network controller 410 may also select a second AID from the set of AP-specific AIDs may transmit an AID assignment indication 415-b to the AP 402-b indicating that the second AID is assigned to the AP 402-b. In some examples, the AID assignment indications 415 may indicate, or the network controller 410 may transmit additional AID assignment indications 415, that indicate the AIDs assigned to the other APs 402 to enable the APs to use the assigned AIDs for TXOP sharing. For example, the AID assignment indication 415-a (or another AID assignment indication 415 transmitted to the AP 402-a) may indicate the second AID assigned to the AP 402-b such that the AP 402-a may include the second AID in a frame 430 to allocate a portion of a TXOP to the AP 402-b. In some other examples, the APs 402 may transmit (such as broadcast) respective AID indications 420 that indicate their respectively assigned AIDs. For example, the AP 402-b may transmit an AID indication 420 to the AP 402-a that indicates the second AID assigned to the AP 402-b by the network controller 410. In some examples, if the network controller 410 is implemented at the AP 402-a, the AP 402-a may select and assign the first AID to itself and may transmit (such as broadcast) one or more AID assignment indications 415 to notify, for example, the AP 402-b that the first AID is associated with the AP 402-a such that the AP 402-b may share a portion of an obtained TXOP with the AP 402-a.

To avoid collision between AIDs assigned to APs 402, the network controller 410 may track which AIDs are assigned to which APs 402. For example, the network controller 410 (such as the AP 402-a if operating as the root AP 402) may store a mapping between AIDs and APs 402 and may use the mapping to select AIDs for assignment to APs 402 that are different from each other. In some examples, a same AID may be used for assignment to multiple APs 402 based on a distance between the APs 402. For example, if two APs 402 are greater than a threshold distance from each other, the network controller 410 may assign a same AID to the two APs 402.

AID assignment by the network controller 410 in a centralized network may reduce a complexity of AP-specific AID assignment and reduce the likelihood of AID collision, among other benefits. For example, non-root APs 402 may be assigned and use an AP-specific AID without performing any AID selection or collision-handling operations, for example, due to AID assignment tracking and collision avoidance handled by the root AP 402 or the network controller 410. Additionally, a root AP 402 or the network controller 410 be a sole assigner of AP-specific AIDs, which may reduce or eliminate AID collision and simplify AID assignment.

Alternatively, the wireless communication network 400 may be an example of a distributed network that excludes the network controller 410. Here, management of the wireless communication network 400 may be jointly handled by one or more APs 402, for example, via the exchange of over-the-air (OTA) messages. In some examples of the wireless communication network 400 being a distributed network, an AP 402 may select its respective AP-specific AID and transmit (such as broadcast) the selected AID to one or more neighboring APs 402 for use in TXOP sharing. For example, the AP 402-a may select an first AP-specific AID (such as the first AID or another AP-specific AID) for the AP 402-a and transmit (such as broadcast) an AID indication 420-a that indicates the first AP-specific AID as being for the AP 402-a. Similarly, the AP 402-b may select a second AP-specific AID (such as the second AID or another AP-specific AID) for the AP 402-b and transmit an AID indication 420-b that indicates the second AP-specific AID as being for the AP 402-b. In some examples, an AID indication 420 may be transmitted via a control frame, a management frame such as a beacon, or a combination thereof.

If AID collision occurs between selected AIDs, such as if the second AP-specific AID is selected by both the AP 402-b and another AP 402 (not shown), the AP 402-a may detect the collision based on respectively received AID indications 420 and transmit a collision indication 425 to the AP 402-b or the other AP 402 to modify (such as reselect) the selected AID to resolve the collision. In the example of FIG. 4, the AP 402-a may transmit the collision indication 425 to the AP 402-b, and the AP 402-b may select a third AP-specific AID for the AP 402-b and transmit an AID indication 420-c indicating the third AP-specific AID.

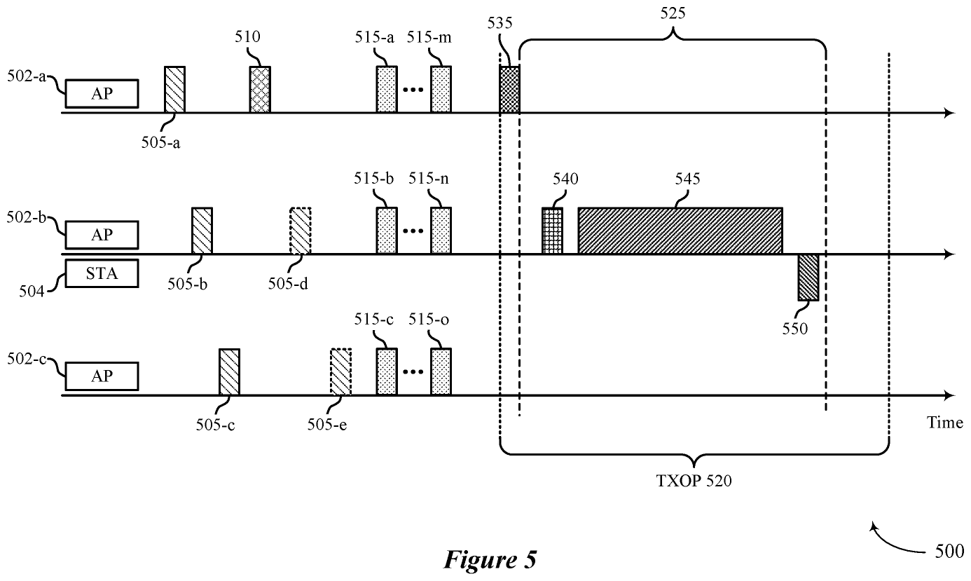

In some other examples of the wireless communication network 400 being a distributed network, an AP 402 may select and assign respective AP-specific AIDs to neighboring APs 402 for use in TXOP sharing. For example, the AP 402-a may select an AP-specific AID for the AP 402-b and may transmit an AID assignment indication 415-c to the AP 402-b that assigns the selected AP-specific AID to the AP 402-b. The AP 402-a may use the selected AP-specific AID to share the portion of the TXOP with the AP 402-b. Additional details associated with AID assignment to neighboring APs are included with reference to FIG. 5 below.

Based on receiving the frame 430, the AP 402-b may communicate one or more frames 440 during the portion of the TXOP allocated to (such as shared with) the AP 402-b. For example, the AP 402-b may communicate one or more frames 440-a with one or more STAs 404 that are a part of a BSS associated with the AP 402-b. Additionally or alternatively, the AP 402-b may communicate one or more frames 440 with one or more APs 402, such as one or more frames 440-b with the AP 402-a or another AP 402. In other words, the AP 402-b may be considered the owner of the portion of the TXOP and may communicate one or more frames 440 with one or more other devices during the TXOP.

In some examples, the AP 402-b may transmit a response frame 435 based on receiving the frame 430. For example, the response frame 435 may be an explicit confirmation of the allocation of the portion of the TXOP to the AP 402-b. In some examples, a type of the response frame 435 may be based on a type of the frame 430. For example, if the frame 430 is a trigger frame, such as an MU-RTS frame or an MU-RTS TXS frame, the response frame 435 may be a clear-to-send (CTS) frame that indicates successful allocation of the portion of the TXOP to the AP 402-b. Alternatively, if the frame 430 is a report poll frame, the response frame 435 may be a report in response to the report poll. For example, if the frame 430 is a BSRP frame, the response frame 435 may be a buffer status report frame that also includes, or serves as, a confirmation of the allocation of the portion of the TXOP to the AP 402-b. In some examples, communication of the one or more frames 440 by the AP 402-b during the portion of the TXOP may be an implicit confirmation of the allocation of the portion of the TXOP to the AP 402-b. Here, no response frame 435 may be transmitted to indicate the confirmation.

FIG. 5 shows an example of a communication sequence 500 that supports AP-to-AP TXOP sharing in accordance with one or more aspects of the present disclosure. The communication sequence 500 may be implemented by aspects of the wireless communication networks 100 and 400 described with reference to FIGS. 1 and 4, respectively. For example, the communication sequence 500 may be implemented by APs 502 and one or more STAs 504, which may be examples of the corresponding devices described herein, including with reference to FIGS. 1 through 4.

The communication sequence 500 shows an example of messaging exchanges that support TXOP sharing between APs 502 using AP-specific AIDs. For example, a first AP 502 may support allocating one or more portions of obtained TXOPs with a second AP 502 using an AP-specific AID associated with the second AP 502. Various techniques may be implemented to support the allocation of AP-specific AIDs to the APs 502 in association with TXOP sharing. For example, a network controller (such as a separate network controller or a root AP 502) may select and assign respective AP-specific AIDs to the APs 502 as described with reference to FIG. 4.

Alternatively, the APs 502 may select their own AIDs from a set of AP-specific AIDs and transmit (such as broadcast) the selected AIDs to neighboring APs 502 via respective AID indications 505. For example, an AP 502-a may select a first AID for the AP 502-a and transmit an AID indication 505-a to one or more neighboring APs 502, such as an AP 502-b, an AP 502-c, or any combination thereof, that indicates the first AID for the AP 502-a. Similarly, the APs 502-b and 502-c may respectively select a second AID for the AP 502-b and a third AID for the AP 502-c and transmit AID indications 505-b and 505-c that indicate the second AID for the AP 502-b and the third AID for the AP 502-c, respectively.

In some examples, there may be a collision between selected AIDs. In some examples, the AID collision may occur based on the AP 502-b and the AP 502-c not being neighboring APs (such as being out of communication range of each other). For example, if the AP 502-a is neighboring both the AP 502-b and the AP 502-c, the AP 502-a may receive respective AID indications 505 and select an AID that is different than those selected by the APs 502-b and 502-c. Similarly, the APs 502-b and 502-c may receive the AID indication 505-a and select an AID that is different that the AID selected by the AP 502-a. However, if the APs 502-b and 502-c are not neighboring, the APs 502-b and 502-c may not receive the respectively transmitted AID indications 505, and the respectively selected AIDs may be unknown to the APs 502-b and 502-c as a result. In some examples, because the APs 502-b and 502-c may be unaware of the respectively selected AIDs, the APs 502-b and 502-c may select a same AID.

To resolve the collision, the AP 502-a may request that one of the APs 502-b and 502-c select a new AID from the set of AP-specific AIDs. For example, the AP 502-a may receive the AID indication 505-b and the AID indication 505-c and determine that there is a match between the AIDs selected by the APs 502-b and 502-c based on the AIDs indicated via the respective AID indications 505. That is, the AP 502-a may determine that the APs 502-b and 502-c selected the same AP-specific AID. The AP 502-a may transmit a collision indication 510 to the AP 502-b or the AP 502-c in response to which the AP 502-b or the AP 502-c may select a new AID for itself and transmit an AID indication 505 (such as an AID indication 505-d or 505-c) that indicates the new AID. For example, the collision indication 510 may indicate that there is a match between the AID selected by the AP 502 and another AP 502, and the AP 502 may select a new AID based on the indication of the match. In some examples, the collision indication 510 may indicate for (such as request) the AP 502 to modify (such as reselect, regenerate) the selected AID, and the AP 502 may select the new AID (such as modify the selected AID to generate the new AID).

To reduce the likelihood of AID collision, an AID selected (such as generated) by an AP 502 may be based on various parameters. For example, the AP 502 may select an AID from the set of AP-specific AIDs (such as generate the AP-specific AID) based on a BSS color associated with the AP 502, a BSSID associated with the AP 502, a compressed BSSID associated with the AP 502, or any combination thereof. For example, a first portion of the AID (such as a first subset of bits of the AID) may correspond to (such as match, be the same as) the BSS color of the AP 502. Additionally or alternatively, a second portion of the AID (such as a second subset of bits of the AID) may correspond to one or more bits of a BSSID of the AP 502 (such as the last 5 bits of the BSSID, or some other subset of bits of the BSSID). Additionally or alternatively, a third portion of the AID (such as a third subset of bits of the AID) may correspond to one or more bits of a compressed BSSID (such as a hashed value of the BSSID) of the AP 502 (such as the last 5 bits of the compressed BSSID, or some other subset of bits of the compressed BSSID).

Alternatively, the APs 502 may select and assign respective AIDs to neighboring APs 502 for use in TXOP sharing. For example, the AP 502-a may select respective AIDs for respective neighboring APs 502 and assign the respective AIDs to the respective neighboring APs 502 via respective AID assignment indications 515 (such as via AID assignment indications 515-a through 515-m). Similarly, the APs 502-b and 502-c may select and assign respective AIDs to respective neighboring APs 502 via respective AID assignment indications (such as via AID assignment indications 515-b through 515-n and AID assignment indications 515-c through 515-0, respectively). Here, each AP 502 may be assigned a respective AID from each of its neighboring APs 502 that the AP 502 and the respective neighboring AP 502 may use in TXOP sharing. For example, the AP 502-b may be assigned a first AID from the AP 502-a and a second AID from the AP 502-c. In some examples, the first AID and the second AID may be the same AID. In some examples, the first AID and the second AID may be different.

The APs 502 may use the allocated AIDs in association with TXOP sharing. In the example of FIG. 5, the AP 502-a may obtain a TXOP 520 and determine to share a portion 525 of the TXOP 520 with the AP 502-b. The AP 502-a may transmit a frame 535 (such as a frame 430) to allocate the portion 525 to the AP 502-b. For example, the AP 502-a may include an AID associated with (such as selected by or assigned to) the AP 502-b in the frame 535 to indicate the AP 502-b as the shared AP 502 (such as recipient AP 502, target AP 502) to be allocated the portion 525.

In some examples, if the AID associated with the AP 502-b is assigned to the AP 502-b by the AP 502-a (such as the first AID assigned via an AID assignment indication 515), AID collision may be avoided by the communication of a tuple in the frame 535 that ensures uniqueness of the indication of the AP 502-b. For example, the AP 502-a may include the first AID in the frame 535 and may also include the BSSID of the AP 502-a (such as the BSSID of the TXOP sharing AP 502). In some examples, the respective BSSIDs of the APs 502 may be different from each other. Accordingly, even if multiple respective AIDs selected by and assigned to other APs 502 are the same, the combination of an assigned AID and a BSSID of the AP 502 that assigned the AID may constitute a unique tuple according to which a shared AP 502 may be identified. For example, to share the portion 525 with the AP 502-b, the AP 502-a may transmit a first frame 535 that includes the AID assigned to the AP 502-b by the AP 502-a and the BSSID of the AP 502-a. Additionally or alternatively, to share a portion 525 of a TXOP 520 obtained by the AP 502-c, the AP 502-c may transmit a second frame 535 that includes the AID assigned to the AP 502-b by the AP 502-c and the BSSID of the AP 502-c. Thus, even if the AP 502-a was assigned, for example, by the AP 502-b or another AP 502, the same AID that was assigned to the AP 502-b by the 502-c, the inclusion of the BSSID of the AP 502-c in the second frame 535 may uniquely identify the AP 502-b as the shared AP. In some examples, the APs 502 may store or otherwise track which AIDs are assigned by which APs such that the APs 502 may properly decode the frame 535 (or other frame that includes the AID associated with the AP 502).

In some examples, the AP 502-b may transmit a confirmation 540 of the allocation of the portion 525 of the TXOP 520 to the AP 502-b. For example, in response to receiving the frame 535, the AP 502-b may transmit the confirmation 540 that the portion 525 is successfully allocated to the AP 502-b.

The AP 502-b may use resources of the portion 525 to communicate one or more frames with one or more devices during the portion 525. In the example of FIG. 5, during the portion 525, the AP 502-b may transmit data 545 to a STA 504 that is a part of a BSS associated with (such as managed by) the AP 502-b, and the STA 504 may transmit a frame 550, such as an acknowledgment (ACK) or negative ACK (NACK), to the AP 502-b in response to transmission of the data 545. In some examples, the communication of the one or more frames during the portion 525 by the AP 502-b may function as an implicit confirmation of the allocation of the portion 525. Here, the AP 502-b may not transmit the confirmation 540.

FIG. 6 shows an example of a frame field diagram 600 that supports AP-to-AP TXOP sharing in accordance with one or more aspects of the present disclosure. The frame field diagram 600 may be implemented by aspects of the wireless communication networks 100 and 400 described with reference to FIGS. 1 and 4, respectively. For example, the frame field diagram 600 may be implemented by an AP described herein, including with reference to FIGS. 1 through 5.

The frame field diagram 600 shows a user information (info) field 605, which may be a field of a frame used to allocate a portion of a TXOP with an indicated AP (which may be referred to as a TXOP sharing frame), such as a frame 430 or a frame 535. The user info field 605 may include various subfields that support the allocation of the portion of the TXOP. For example, the user info field may include an AID subfield 610, an RU allocation subfield 615, an allocation duration subfield 620, a reserved subfield 625, a PS160 subfield 630 or a combination thereof. The AID subfield 610 may include an AP-specific AID of the AP to which the portion of the TXOP is allocated. In some examples, the AID subfield 610 may be a 12 bit subfield (or some other quantity of bits). In some examples, the AID subfield 610 may be referred to as an AID12 subfield of the user info field 605. The RU allocation subfield 615, the PS160 subfield 630 or a combination thereof, may indicate one or more RUs of the portion of the TXOP allocated to the AP. In some examples, the RU allocation subfield 615 may be an 8 bit subfield (or some other quantity of bits). The allocation duration subfield 620 may indicate a duration of the portion of the TXOP allocated to the AP. In some examples, the allocation duration subfield 620 may be a 9 bit subfield (or some other quantity of bits). The reserved subfield 625 may be a set of bits of the user info field 605 that are unused or otherwise reserved for other or future purposes. In some examples, the reserved subfield 625 may be an 10 bit subfield (or some other quantity of bits).

In some examples, one or more bits of the reserved subfield 625 may be used to further increase the quantity of possible AP-specific AIDs. For example, one or more bits of the reserved subfield 625 may be allocated to the AID subfield 610 to increase quantity of bits included in the AID subfield, thereby increasing the quantity of AP-specific AIDs from which the AP-specific AID may be selected for inclusion in the TXOP sharing frame.

The frame field diagram 600 shows example subsets of AIDs that may be included in the AID subfield 610 and the corresponding indication (PS160 subfield 630) if an AID within the subset is used. For example, if the AID subfield is a 12 bit subfield, AIDs 0 through 4095 may be indicated by the AID subfield 610. The frame field diagram 600 shows an example partitioning of the AIDs 0 through 4095 into various subsets of AIDs, although other AID partitioning is possible.

In the example of FIG. 6, AID 0 and AID 2045 may indicate that the user info field 605 allocates one or more contiguous RU allocations (such as random access (RA) RUs) for associated STAs and unassociated STAs, respectively. AIDs 1 through 2007 may indicate that the user info field is addressed to an associated STA whose AID is equal to the value in the AID subfield 610. AID 2046 may indicate that the one or more RUs indicated in the RU allocation subfield 615 are unallocated RUs. AID 4095 may be disallowed to indicate an AID of a device or contiguous RU allocation and instead may be used to indicate the start of a padding field.

Various AIDs of AIDs 0 through 4095 may be unused for the purposes described above and may instead be allocated for identifying APs in association with TXOP sharing. For example, AIDs where the most significant bit (MSB) is equal to 1, such as AIDs excluding 2047 through 4094 (excluding AID 4095), may be allocated and used as AP-specific AIDs. Additionally or alternatively, AIDs 2008 through 2044 may be unused for the purposes described above and may be allocated and used as AP-specific AIDs. Additionally or alternatively, a subset of the AIDs 1 through 2007 may be allocated and used as AP-specific AIDs. For example, if the TXOP sharing frame is associated with communication of (such as included in, triggering communication of) an HE MU PPDU or an EHT MU PPDU, one or more AIDs of the AIDs 1 through 2007 may be unused to identify a STA (such as a non-AP STA). For example, in the example of FIG. 6, AIDs 1 through 48 may be AIDs associated with an HE MU PPDU or an EHT MU PPDU that may be unused to identify a STA. As such, AIDs 1 through 48 may be allocated and used as AP-specific AIDs if they are unused as STA-specific AIDs. In some examples, if one or more reserved bits are allocated to the AID subfield 610, AIDs that may be indicated due to the allocation of the reserved bits to the AID subfield 610 may be AP-specific AIDs.

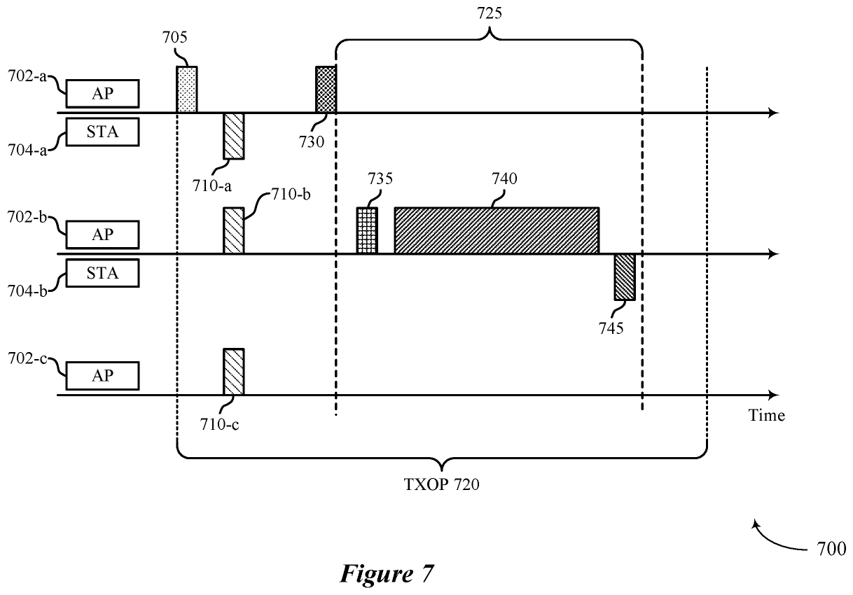

FIG. 7 shows an example of a communication sequence 700 that supports AP-to-AP TXOP sharing in accordance with one or more aspects of the present disclosure. The communication sequence 700 may be implemented by aspects of the wireless communication networks 100 and 400 described with reference to FIGS. 1 and 4, respectively. For example, the communication sequence 700 may be implemented by APs 702 and one or more STAs 704, which may be examples of the corresponding devices described herein, including with reference to FIGS. 1 through 6.

The communication sequence 700 shows an example of messaging exchanges that support TXOP sharing between APs 502 using AP-specific AIDs. For example, an AP 702-a may obtain a TXOP 720 and determine to allocate a portion 725 of the TXOP 720 to another AP 702. The AP 702-a may communicate one or more messages to determine with which AP 702 to share the portion 725 of the TXOP 720. For example, the AP 702-a may transmit (such as broadcast) a frame 705 that triggers a set of STAs to indicate whether a respective STA requests the allocation of the portion 725, to indicate a priority associated with traffic to be communicated during the portion 725, or a combination thereof. For example, APs 702 may be considered STAs, and so are non-AP STAs associated with APs 702. For instance, the communication sequence 700 shows APs 702 and STAs 704 triggered by the frame 705. In some examples, the APs 702 may be STAs that function as APs, and the STAs 704 may be non-AP STAs. Accordingly, the set of STAs triggered by the frame 705 may include APs 702, such as an AP 702-b and an AP 702-c, one or more STAs 704, such as a STA 704-a that is a part of a BSS associated with the AP 702-a, or a combination thereof.

In the example of FIG. 7, the set of STAs may include the STA 704-a, the AP 702-b, and the AP 702-c. In response to the frame 705, the set of STAs may transmit a response frame 710 that indicates whether the respective STA requests the allocation of the portion 725, a priority associated with respective traffic to be communicated during the portion 725, or a combination thereof. In one implementation, the priority may be indicated by one bit to indicate whether the respective traffic has high priority. In another implementation, the priority may be indicated by multiple bits to indicate the one or more access categories to which the respective traffic belongs. For example, if a total of four bits are used for the indication, a first bit may be used to indicate whether the respective traffic includes one or more frames of the best effort (BE) access category, a second bit may be used to indicate whether the respective traffic includes one or more frames of the back ground (BK) access category, a third bit may be used to indicate whether the respective traffic includes one or more frames of the voice (VO) access category, and the last bit may be used to indicate whether the respective traffic includes one or more frames of the video (VI) access category. In the example of FIG. 7, the STA 704-a may transmit a response frame 710-a to indicate that the STA 704-a does not request the allocation of the portion 725.

In some examples, the AP 702-b may transmit a response frame 710-b to indicate that the AP 702-b does request the allocation of the portion 725, and the AP 702-c may transmit a response frame 710-c to indicate that the AP 702-c does not request the allocation of the portion 725. Here, the AP 702-a may select the AP 702-b that requested the allocation of the portion 725, for example, based on no other AP 702 requesting the allocation of the portion 725, and transmit a frame 730 (such as a TXOP sharing frame, a frame 430, a frame 535) that includes an AP-specific AID associated with the AP 702-b to allocates the portion 725 to the AP 702-b.

In some examples, multiple APs 702 may request for the allocation of the portion 725. For example, the response frame 710-b and the response frame 710-c may each indicate that the APs 702-b and 702-c, respectively, request for the allocation of the portion 725. Here, the AP 702-a may select which AP 702 to allocate the portion 725 based on a priority of respective traffic indicated via the response frames 710. For instance, in the example of FIG. 7, the response frame 710-b may indicate a first priority associated with first traffic to be communicated during the portion 725 by the AP 702-b, and the response frame 710-c may indicate a second priority associated with second traffic to be communicated during the portion 725 by the AP 702-c. The AP 702-a may select the AP 702-b based on the first priority being greater (such as higher) than the second priority and transmit the frame 730 to the AP 702-b.

In some examples, the frame 705 may be a trigger frame. In some examples, the frame 705 may be a report poll message, such as a BSRP frame or an NFRP frame. In some examples, the priority of the traffic indicated in a response frame 710 may be a buffer status report or a feedback report transmitted in response to the BSRP frame or the NFRP frame, respectively.

The AP 702-b may communicate one or more frames during the portion 725 of the TXOP 720 based on being allocated the portion 725. For example, in some cases, the AP 702-b may transmit, to the AP 702-a, a confirmation 735 of the allocation of the portion 725 to the AP 702-b. In the example of FIG. 7, during the portion 725, the AP 502-b may transmit data 740 to a STA 704-b that is a part of a BSS associated with (such as managed by) the AP 702-b, and the STA 704-b may transmit a frame 745, such as an ACK or NACK, to the AP 702-b in response to transmission of the data 740. In some examples, the communication of the one or more frames during the portion 725 by the AP 702-b may function as an implicit confirmation of the allocation of the portion 725. Here, the AP 702-b may not transmit the confirmation 735.

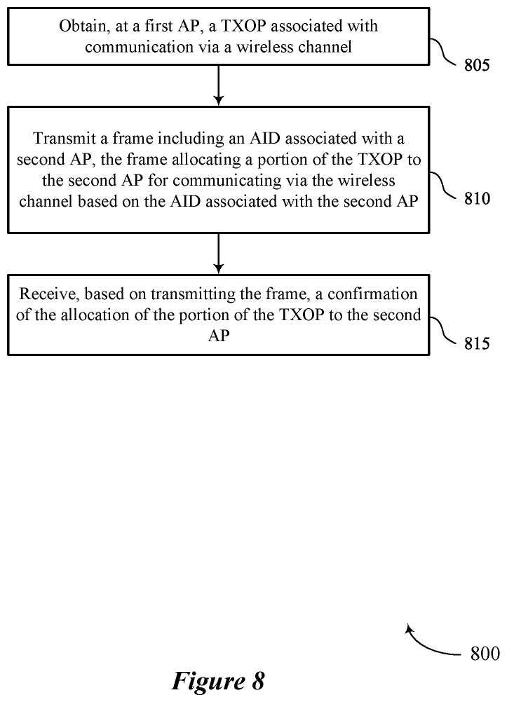

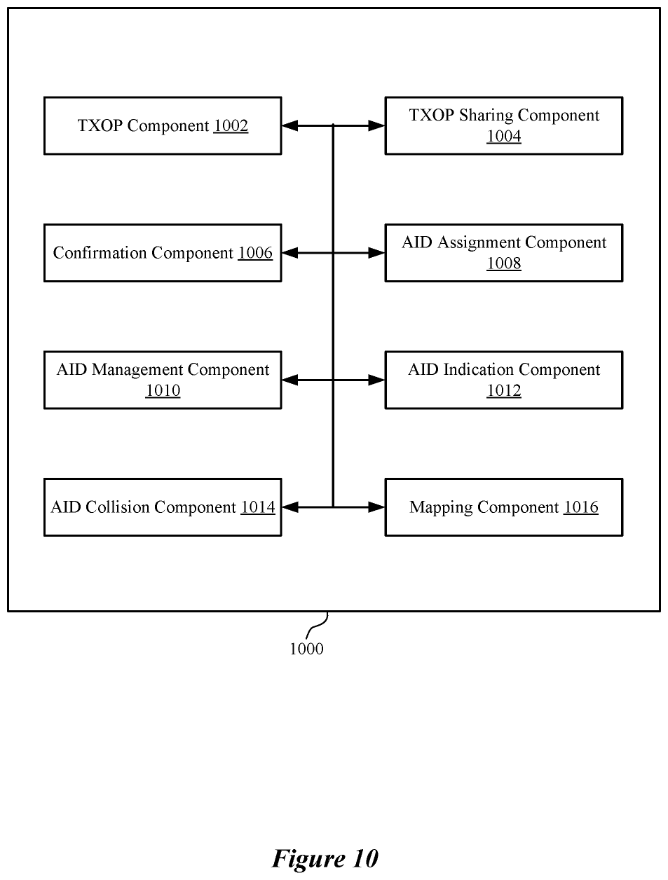

FIG. 8 shows a flowchart illustrating an example process 800 performable at a wireless AP that supports AP-to-AP TXOP sharing in accordance with one or more aspects of the present disclosure. The operations of the process 800 may be implemented by an AP or its components as described herein. For example, the operations of the process 800 may be performed by a wireless communication device, such as the wireless communication device 1000 described with reference to FIG. 10, operating as or within a wireless AP as described with reference to FIGS. 1 through 7 and 10. In some examples, an AP may execute a set of instructions to control the functional elements of the AP to perform the described functions. Additionally, or alternatively, the AP may perform aspects of the described functions using special-purpose hardware.

In some examples, at 805, the process may include obtaining, at a first AP, a TXOP associated with communication via a wireless channel. The operations of 805 may be performed in accordance with examples as disclosed herein, such as the obtainment of a TXOP of FIG. 1, the obtainment of a TXOP of FIG. 4, the obtainment of a TXOP 520 of FIG. 5 and/or the obtainment of a TXOP 720 of FIG. 7. In some examples, aspects of the operations of 805 may be performed by a TXOP component 1002 as described with reference to FIG. 10.

In some examples, at 810, the process may include transmitting a frame including an AID associated with a second AP, the frame allocating a portion of the TXOP to the second AP for communicating via the wireless channel based on the AID associated with the second AP. The operations of 810 may be performed in accordance with examples as disclosed herein, such as the transmission of a frame 430 of FIG. 4, the transmission of a frame 535 of FIG. 5, and/or the transmission of a frame 705 or a frame 730 of FIG. 7. The frame may include information similar to that described with respect to, and illustrated in, FIG. 6. In some examples, aspects of the operations of 810 may be performed by a TXOP sharing component 1004 as described with reference to FIG. 10.

In some examples, at 815, the process may include receiving, based on transmitting the frame, a confirmation of the allocation of the portion of the TXOP to the second AP. The operations of 815 may be performed in accordance with examples as disclosed herein, such as the reception of a response frame 435 of FIG. 4, the reception of a response frame (confirmation 540) of FIG. 5, and/or the reception of a response frame (confirmation 735) of FIG. 7. In some examples, aspects of the operations of 815 may be performed by a confirmation component 1006 as described with reference to FIG. 10.

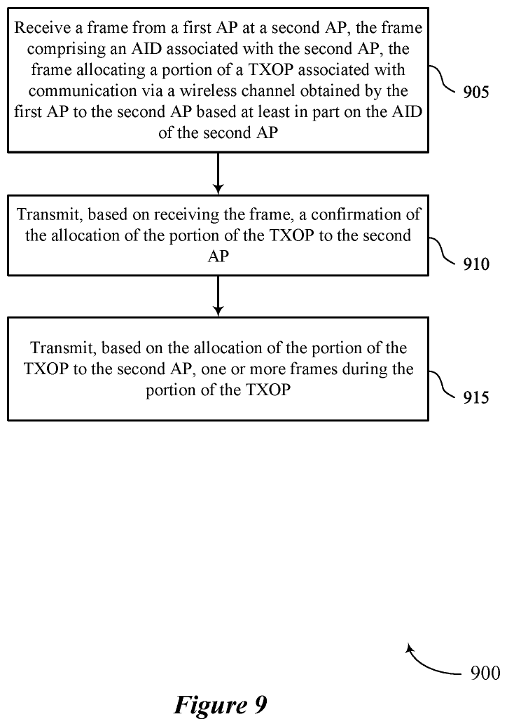

FIG. 9 shows a flowchart illustrating an example process 900 performable at a wireless AP that supports AP-to-AP TXOP sharing in accordance with one or more aspects of the present disclosure. The operations of the process 900 may be implemented by an AP or its components as described herein. For example, the operations of the process 900 may be performed by a wireless communication device, such as the wireless communication device 1000 described with reference to FIG. 10, operating as or within a wireless AP as described with reference to FIGS. 1 through 7 and 10. In some examples, an AP may execute a set of instructions to control the functional elements of the AP to perform the described functions. Additionally, or alternatively, the AP may perform aspects of the described functions using special-purpose hardware.

In some examples, at 905, the process may include receiving a frame from a first AP at a second AP, the frame including an AID associated with the second AP, the frame allocating a portion of a TXOP associated with communication via a wireless channel obtained by the first AP to the second AP based on the AID of the second AP. The operations of 905 may be performed in accordance with examples as disclosed herein, such as the reception of a frame 430 of FIG. 4, the reception of a frame 535 of FIG. 5, and/or the reception of a frame 705 or a frame 730 of FIG. 7. The frame may include information similar to that described with respect to, and illustrated in, FIG. 6. In some examples, aspects of the operations of 905 may be performed by a TXOP sharing component 1004 as described with reference to FIG. 10.

In some examples, at 910, the process may include transmitting, based on receiving the frame, a confirmation of the allocation of the portion of the TXOP to the second AP. The operations of 910 may be performed in accordance with examples as disclosed herein, such as the transmission of a response frame 435 of FIG. 4, the transmission of a response frame (confirmation 540) of FIG. 5, and/or the transmission of a response frame (confirmation 735) of FIG. 7. In some examples, aspects of the operations of 910 may be performed by a confirmation component 1006 as described with reference to FIG. 10.

In some examples, at 915, the process may include transmitting, based on the allocation of the portion of the TXOP to the second AP, one or more frames during the portion of the TXOP. The operations of 915 may be performed in accordance with examples as disclosed herein, such as the transmission of a frame 440 of FIG. 4, the transmission of data 545 of FIG. 5, and/or the transmission of data 740 of FIG. 7. In some examples, aspects of the operations of 915 may be performed by a TXOP component 1002 as described with reference to FIG. 10.

FIG. 10 shows a block diagram of an example wireless communication device 1000 that supports AP-to-AP TXOP sharing in accordance with one or more aspects of the present disclosure. In some examples, the wireless communication device 1000 is configured or operable to perform the processes 800 or 900 described with reference to FIGS. 8 and 9. In various examples, the wireless communication device 1000 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1000 can be a device for use in an AP, such as AP 102 described with reference to FIG. 1. In some other examples, the wireless communication device 1000 can be an AP that includes such a chip, SoC, chipset, package or device as well as multiple antennas. The wireless communication device 1000 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1000 also includes or can be coupled with an application processor which may be further coupled with another memory. In some examples, the wireless communication device 1000 further includes at least one external network interface that enables communication with a core network or backhaul network to gain access to external networks including the Internet.

The wireless communication device 1000 may be an example of aspects of an AP as described with reference to FIGS. 1 through 7. The AP 1020, or various components thereof, may be an example of means for performing various aspects of AP-to-AP TXOP sharing as described herein. For example, the AP 1020 may include a TXOP component 1002, a TXOP sharing component 1004, a confirmation component 1006, an AID assignment component 1008, an AID management component 1010, an AID indication component 1012, an AID collision component 1014, a mapping component 1016, or any combination thereof. Each of these components may communicate, directly or indirectly, with one another (e.g., via one or more buses). Portions of one or more of the components 1002, 1004, 1006, 1008, 1010, 1012, 1014, and 1016 may be implemented at least in part in hardware or firmware. For example, the TXOP sharing component 1004 may be implemented at least in part by a modem. In some examples, at least some of the components 1002. 1004, 1006, 1008, 1010, 1012, 1014, and 1016 are implemented at least in part by a processor and as software stored in a memory. For example, portions of one or more of the components 1002, 1004, 1006, 1008, 1010, 1012, 1014, and 1016 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the device 1000). For example, a processing system of the device 1000 may refer to a system including the various other components or subcomponents of the device 1000, such as the processor, or a transceiver, or a communications manager, or other components or combinations of components of the device 1000. The processing system of the device 1000 may interface with other components of the device 1000, and may process information received from other components (such as inputs or signals) or output information to other components. For example, a chip or modem of the device 1000 may include a processing system, a first interface to output information and a second interface to obtain information. In some implementations, the first interface may refer to an interface between the processing system of the chip or modem and a transmitter, such that the device 1000 may transmit information output from the chip or modem. In some implementations, the second interface may refer to an interface between the processing system of the chip or modem and a receiver, such that the device 1000 may obtain information or signal inputs, and the information may be passed to the processing system. A person having ordinary skill in the art will readily recognize that the first interface also may obtain information or signal inputs, and the second interface also may output information or signal outputs.

The device 1000 may support wireless communications in accordance with examples as disclosed herein. The TXOP component 1002 may be configured as or otherwise support a means for obtaining, at a first AP (the device 1000), a TXOP associated with communication via a wireless channel. The TXOP sharing component 1004 may be configured as or otherwise support a means for transmitting a frame including an AID associated with a second AP, the frame allocating a portion of the TXOP to the second AP for communicating via the wireless channel based on the AID associated with the second AP. The confirmation component 1006 may be configured as or otherwise support a means for receiving, based on transmitting the frame, a confirmation of the allocation of the portion of the TXOP to the second AP.

In some examples, the AID assignment component 1008 may be configured as or otherwise support a means for receiving, via a backhaul link associated with a network controller that is associated with the first AP and the second AP, an indication that the AID is assigned to the second AP. In some examples, to transmit the frame, the TXOP sharing component 1004 may be configured as or otherwise support a means for transmitting the frame based on the indication.

In some examples, the AID management component 1010 may be configured as or otherwise support a means for selecting the AID associated with the second AP from a set of AIDs specific to APs. In some examples, the AID assignment component 1008 may be configured as or otherwise support a means for transmitting, based on the selecting, an indication that the AID is assigned to the second AP. In some examples, to transmit the frame, the TXOP sharing component 1004 may be configured as or otherwise support a means for transmitting the frame based on the indication.

In some examples, the frame includes an indication of a BSSID associated with the first AP.

In some examples, the mapping component 1016 may be configured as or otherwise support a means for storing a mapping between AIDs and APs. In some examples, to select the AID, the AID management component 1010 may be configured as or otherwise support a means for selecting the AID to be different from AIDs associated with one or more other APs based on the mapping.

In some examples, the AID indication component 1012 may be configured as or otherwise support a means for receiving, via a communication link between the first AP and the second AP, a first indication that the AID is associated with the second AP. In some examples, to transmit the frame, the TXOP sharing component 1004 may be configured as or otherwise support a means for transmitting the frame based on the first indication.

In some examples, the AID indication component 1012 may be configured as or otherwise support a means for receiving, via a communication link between the first AP and a third AP, a second indication of an AID associated with the third AP. In some examples, the AID collision component 1014 may be configured as or otherwise support a means for transmitting, via the communication link between the first AP and the third AP, a third indication to modify the AID associated with the third AP based on a match between the AID associated with the second AP and the AID associated with the third AP.

In some examples, the AID associated with the second AP is based on a BSS color associated with the second AP, a BSSID associated with the second AP, a compressed BSSID associated with the second AP, or any combination thereof.

In some examples, the AID indication component 1012 may be configured as or otherwise support a means for receiving, via a communication link between the first AP and the second AP, a first indication of a second AID associated with the second AP. In some examples, the AID collision component 1014 may be configured as or otherwise support a means for transmitting, via the communication link, a second indication that the second AID associated with the second AP matches an AID associated with a third AP. In some examples, the AID indication component 1012 may be configured as or otherwise support a means for receiving, via the communication link based on the second indication, a third indication of the AID associated with the second AP.

In some examples, the TXOP sharing component 1004 may be configured as or otherwise support a means for transmitting a second frame, the second frame being associated with triggering the second AP to request the allocation of the portion of the TXOP. In some examples, the TXOP sharing component 1004 may be configured as or otherwise support a means for receiving a response frame indicating that the second AP requests the allocation of the portion of the TXOP. In some examples, to transmit the frame, the TXOP sharing component 1004 may be configured as or otherwise support a means for transmitting the frame based on the response frame.

In some examples, the second frame is a BSRP frame or an NFRP frame.

In some examples, the TXOP sharing component 1004 may be configured as or otherwise support a means for transmitting a second frame, the second frame being associated with triggering a set of stations including the second AP to indicate whether a respective station requests the allocation of the portion of the TXOP and to indicate a priority associated with traffic to be communicated during the portion of the TXOP. In some examples, the TXOP sharing component 1004 may be configured as or otherwise support a means for receiving a first response frame indicating that the second AP requests the allocation of the portion of the TXOP and indicating a first priority associated with first traffic to be communicated during the portion of the TXOP by the second AP. In some examples, the TXOP sharing component 1004 may be configured as or otherwise support a means for receiving a second response frame indicating that a third AP requests the allocation of the portion of the TXOP and indicating a second priority associated with second traffic to be communicated during the portion of the TXOP by the third AP. In some examples, the TXOP sharing component 1004 may be configured as or otherwise support a means for selecting the second AP for allocation of the portion of the TXOP based on the first priority being greater than the second priority. In some examples, to the transmit the frame, the TXOP sharing component 1004 may be configured as or otherwise support a means for transmitting the frame based on the selecting.

In some examples, the frame is a trigger frame including an MU-RTS frame, an MU-RTS TXS frame, a BSRP frame, or an NFRP frame. In some examples, the AID associated with the second AP is included in an AID12 subfield of a user information field of the trigger frame.

In some examples, the AID associated with the second AP is included in a set of AIDs for identifying a respective AP, a set of AIDs having a most significant bit of 1, a set of AIDs associated with an HE MU PPDU, a set of AIDs associated with an EHT MU PPDU, or any combination thereof.

Additionally, or alternatively, the device 1000 may support wireless communications in accordance with examples as disclosed herein. In some examples, the TXOP sharing component 1004 may be configured as or otherwise support a means for receiving a frame from a first AP at a second AP (the device 1000), the frame including an AID associated with the second AP, the frame allocating a portion of a TXOP associated with communication via a wireless channel obtained by the first AP to the second AP based on the AID of the second AP. In some examples, the confirmation component 1006 may be configured as or otherwise support a means for transmitting, based on receiving the frame, a confirmation of the allocation of the portion of the TXOP to the second AP. In some examples, the TXOP component 1002 may be configured as or otherwise support a means for transmitting, based on the allocation of the portion of the TXOP to the second AP, one or more frames during the portion of the TXOP.

In some examples, the AID assignment component 1008 may be configured as or otherwise support a means for receiving, via a backhaul link associated with a network controller that is associated with the first AP and the second AP, an indication that the AID is assigned to the second AP. In some examples, to receive the frame, the TXOP sharing component 1004 may be configured as or otherwise support a means for receiving the frame based on the indication.

In some examples, the AID assignment component 1008 may be configured as or otherwise support a means for receiving, via a communication link between the first AP and the second AP, an indication that the AID is assigned to the second AP. In some examples, to receive the frame, the TXOP sharing component 1004 may be configured as or otherwise support a means for receiving the frame based on the indication.

In some examples, the frame includes an indication of a BSSID associated with the first AP.

In some examples, the AID assignment component 1008 may be configured as or otherwise support a means for receiving, via a communication link between the second AP and a third AP, a second indication that a second AID is assigned to the second AP. In some examples, the TXOP sharing component 1004 may be configured as or otherwise support a means for receiving a second frame from the third AP at the second AP, the second frame including the second AID associated with the second AP, the second frame allocating a portion of a second TXOP associated with communication via the wireless channel obtained by the third AP to the second AP based on the second AID of the second AP. In some examples, the TXOP component 1002 may be configured as or otherwise support a means for transmitting, based on the allocation of the portion of the second TXOP to the second AP, one or more frames during the portion of the second TXOP.

In some examples, the AID management component 1010 may be configured as or otherwise support a means for selecting the AID associated with the second AP from a set of AIDs specific to APs. In some examples, the AID indication component 1012 may be configured as or otherwise support a means for transmitting, based on the selecting, an indication of the AID associated with the second AP to the first AP. In some examples, to receive the frame, the TXOP sharing component 1004 may be configured as or otherwise support a means for receiving the frame based on the indication.

In some examples, the AID associated with the second AP is selected based on a BSS color associated with the second AP, a BSSID associated with the second AP, a compressed BSSID associated with the second AP, or any combination thereof.

In some examples, the AID indication component 1012 may be configured as or otherwise support a means for transmitting, via a communication link between the first AP and the second AP, a first indication of a second AID associated with the second AP to the first AP. In some examples, the AID collision component 1014 may be configured as or otherwise support a means for receiving, via the communication link, a second indication that the second AID associated with the second AP matches an AID associated with a third AP. In some examples, the AID management component 1010 may be configured as or otherwise support a means for selecting, based on the second indication, the AID for association with the second AP. In some examples, the AID indication component 1012 may be configured as or otherwise support a means for transmitting, via the communication link based on the selecting, a third indication of the AID associated with the second AP.

In some examples, the TXOP sharing component 1004 may be configured as or otherwise support a means for receiving a second frame, the second frame being associated with triggering the second AP to request the allocation of the portion of the TXOP. In some examples, the TXOP sharing component 1004 may be configured as or otherwise support a means for transmitting a response frame indicating that the second AP requests the allocation of the portion of the TXOP. In some examples, to receive the frame, the TXOP sharing component 1004 may be configured as or otherwise support a means for receiving the frame based on the response frame.

In some examples, the second frame is a BSRP frame or an NFRP frame.

In some examples, the TXOP sharing component 1004 may be configured as or otherwise support a means for receiving a second frame, the second frame being associated with triggering a set of stations including the second AP to indicate whether a respective station requests the allocation of the portion of the TXOP and to indicate a priority associated with traffic to be communicated during the portion of the TXOP. In some examples, the TXOP sharing component 1004 may be configured as or otherwise support a means for transmitting a first response frame indicating that the second AP requests the allocation of the portion of the TXOP and indicating a first priority associated with first traffic to be communicated during the portion of the TXOP by the second AP. In some examples, to receive the frame, the TXOP sharing component 1004 may be configured as or otherwise support a means for receiving the frame based on the first priority being greater than a respective priority indicated by other APs of the set of stations.

In some examples, the frame is a trigger frame including an MU-RTS frame, an MU-RTS TXS frame, a BSRP frame, or an NFRP frame. In some examples, the AID associated with the second AP is included in an AID12 subfield of a user information field of the trigger frame.

In some examples, the AID associated with the second AP is included in a set of AIDs for identifying a respective AP, a set of AIDs having a most significant bit of 1, a set of AIDs associated with an HE MU PPDU, a set of AIDs associated with an EHT MU PPDU, or any combination thereof.

Implementation examples are described in the following numbered clauses:

Clause 1: A method for wireless communications, including: obtaining, at a first AP, a TXOP associated with communication via a wireless channel; transmitting a frame including an AID associated with a second AP, the frame allocating a portion of the TXOP to the second AP for communicating via the wireless channel based at least in part on the AID associated with the second AP; and receiving, based at least in part on transmitting the frame, a confirmation of the allocation of the portion of the TXOP to the second AP.

Clause 2: The method of clause 1, further including: receiving, via a backhaul link associated with a network controller that is associated with the first AP and the second AP, an indication that the AID is assigned to the second AP, where transmitting the frame includes: transmitting the frame based at least in part on the indication.

Clause 3: The method of clause 1, further including: selecting the AID associated with the second AP from a set of AIDs specific to APs; and transmitting, based at least in part on the selecting, an indication that the AID is assigned to the second AP, where transmitting the frame includes: transmitting the frame based at least in part on the indication.

Clause 4: The method of clause 3, where the frame includes an indication of a BSSID associated with the first AP.

Clause 5: The method of any of clauses 3 through 4, further including: storing a mapping between AIDs and APs, where selecting the AID further includes: selecting the AID to be different from AIDs associated with one or more other APs based at least in part on the mapping.

Clause 6: The method of clause 1, further including: receiving, via a communication link between the first AP and the second AP, a first indication that the AID is associated with the second AP, where transmitting the frame includes: transmitting the frame based at least in part on the first indication.

Clause 7: The method of clause 6, further including: receiving, via a communication link between the first AP and a third AP, a second indication of an AID associated with the third AP; and transmitting, via the communication link between the first AP and the third AP, a third indication to modify the AID associated with the third AP based at least in part on a match between the AID associated with the second AP and the AID associated with the third AP.

Clause 8: The method of any of clauses 6 through 7, where the AID associated with the second AP is based at least in part on a BSS color associated with the second AP, a BSSID associated with the second AP, a compressed BSSID associated with the second AP, or any combination thereof.

Clause 9: The method of any of clauses 1 and 6 through 8, further including: receiving, via a communication link between the first AP and the second AP, a first indication of a second AID associated with the second AP; transmitting, via the communication link, a second indication that the second AID associated with the second AP matches an AID associated with a third AP; and receiving, via the communication link based at least in part on the second indication, a third indication of the AID associated with the second AP.

Clause 10: The method of any of clauses 1 through 9, further including: transmitting a second frame, the second frame being associated with triggering the second AP to request the allocation of the portion of the TXOP; and receiving a response frame indicating that the second AP requests the allocation of the portion of the TXOP, where transmitting the frame includes: transmitting the frame based at least in part on the response frame.

Clause 11: The method of clause 10, where the second frame is a BSRP frame or a NFRP frame.

Clause 12: The method of any of clauses 1 through 11, further including: transmitting a second frame, the second frame being associated with triggering a set of STAs including the second AP to indicate whether a respective STA requests the allocation of the portion of the TXOP and to indicate a priority associated with traffic to be communicated during the portion of the TXOP; receiving a first response frame indicating that the second AP requests the allocation of the portion of the TXOP and indicating a first priority associated with first traffic to be communicated during the portion of the TXOP by the second AP; receiving a second response frame indicating that a third AP requests the allocation of the portion of the TXOP and indicating a second priority associated with second traffic to be communicated during the portion of the TXOP by the third AP; and selecting the second AP for allocation of the portion of the TXOP based at least in part on the first priority being greater than the second priority, where the transmitting the frame includes: transmitting the frame based at least in part on the selecting.

Clause 13: The method of any of clauses 1 through 12, where the frame is a trigger frame including an MU-RTS frame, an MU-RTS TXS frame, a BSRP frame, or a NFRP frame, and the AID associated with the second AP is included in an AID12 subfield of a user information field of the trigger frame.

Clause 14: The method of any of clauses 1 through 13, where the AID associated with the second AP is included in a set of AIDs for identifying a respective AP, a set of AIDs having a most significant bit of 1, a set of AIDs associated with an HE MU PPDU, a set of AIDs associated with an EHT MU PPDU, or any combination thereof.

Clause 15: A method for wireless communications, including: receiving a frame from a first AP at a second AP, the frame including an AID associated with the second AP, the frame allocating a portion of a TXOP associated with communication via a wireless channel obtained by the first AP to the second AP based at least in part on the AID of the second AP; transmitting, based at least in part on receiving the frame, a confirmation of the allocation of the portion of the TXOP to the second AP; and transmitting, based at least in part on the allocation of the portion of the TXOP to the second AP, one or more frames during the portion of the TXOP.

Clause 16: The method of clause 15, further including: receiving, via a backhaul link associated with a network controller that is associated with the first AP and the second AP, an indication that the AID is assigned to the second AP, where receiving the frame includes: receiving the frame based at least in part on the indication.

Clause 17: The method of clause 15, further including: receiving, via a communication link between the first AP and the second AP, an indication that the AID is assigned to the second AP, where receiving the frame includes: receiving the frame based at least in part on the indication.

Clause 18: The method of clause 17, where the frame includes an indication of a BSSID associated with the first AP.

Clause 19: The method of any of clauses 17 through 18, further including: receiving, via a communication link between the second AP and a third AP, a second indication that a second AID is assigned to the second AP; receiving a second frame from the third AP at the second AP, the second frame including the second AID associated with the second AP, the second frame allocating a portion of a second TXOP associated with communication via the wireless channel obtained by the third AP to the second AP based at least in part on the second AID of the second AP; and transmitting, based at least in part on the allocation of the portion of the second TXOP to the second AP, one or more frames during the portion of the second TXOP.

Clause 20: The method of clause 15, further including: selecting the AID associated with the second AP from a set of AIDs specific to APs; and transmitting, based at least in part on the selecting, an indication of the AID associated with the second AP to the first AP, where receiving the frame includes: receiving the frame based at least in part on the indication.

Clause 21: The method of clause 20, where the AID associated with the second AP is selected based at least in part on a BSS color associated with the second AP, a BSSID associated with the second AP, a compressed BSSID associated with the second AP, or any combination thereof.

Clause 22: The method of any of clauses 15 and 20 through 21, further including: transmitting, via a communication link between the first AP and the second AP, a first indication of a second AID associated with the second AP to the first AP; receiving, via the communication link, a second indication that the second AID associated with the second AP matches an AID associated with a third AP; selecting, based at least in part on the second indication, the AID for association with the second AP; and transmitting, via the communication link based at least in part on the selecting, a third indication of the AID associated with the second AP.

Clause 23: The method of any of clauses 15 through 22, further including: receiving a second frame, the second frame being associated with triggering the second AP to request the allocation of the portion of the TXOP; and transmitting a response frame indicating that the second AP requests the allocation of the portion of the TXOP, where receiving the frame includes: receiving the frame based at least in part on the response frame.

Clause 24: The method of clause 23, where the second frame is a BSRP frame or a NFRP frame.

Clause 25: The method of any of clauses 15 through 24, further including: receiving a second frame, the second frame being associated with triggering a set of STAs including the second AP to indicate whether a respective STA requests the allocation of the portion of the TXOP and to indicate a priority associated with traffic to be communicated during the portion of the TXOP; and transmitting a first response frame indicating that the second AP requests the allocation of the portion of the TXOP and indicating a first priority associated with first traffic to be communicated during the portion of the TXOP by the second AP, where receiving the frame includes: receiving the frame based at least in part on the first priority being greater than a respective priority indicated by other APs of the set of STAs.

Clause 26: The method of any of clauses 15 through 25, where the frame is a trigger frame including an MU-RTS frame, an MU-RTS TXS frame, a BSRP frame, or a NFRP frame, and the AID associated with the second AP is included in an AID12 subfield of a user information field of the trigger frame.

Clause 27: The method of any of clauses 15 through 26, where the AID associated with the second AP is included in a set of AIDs for identifying a respective AP, a set of AIDs having a most significant bit of 1, a set of AIDs associated with a HE MU PPDU, a set of AIDs associated with an EHT MU PPDU, or any combination thereof.

Clause 28: A first AP, including at least one memory; and at least one processor communicatively coupled with the at least one memory, the at least one processor operable to cause the first AP to perform a method of any of clauses 1 through 14.

Clause 29: A first AP, including at least one means for performing a method of any of clauses 1 through 14.

Clause 30: A non-transitory computer-readable medium storing code for wireless communications, the code including instructions executable by a processor to perform a method of any of clauses 1 through 14.

Clause 31: A second AP, including at least one memory; and at least one processor communicatively coupled with the at least one memory, the at least one processor operable to cause the second AP to perform a method of any of clauses 15 through 27.

Clause 32: A second AP, including at least one means for performing a method of any of clauses 15 through 27.

Clause 33: A non-transitory computer-readable medium storing code for wireless communications, the code including instructions executable by a processor to perform a method of any of clauses 15 through 27.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
at least one memory; and
at least one processor communicatively coupled with the at least one memory, the at least one processor operable to cause the first AP to:
obtain a transmission opportunity associated with communication via a wireless channel;
transmit a frame comprising an association identifier associated with a second AP, the frame allocating a portion of the transmission opportunity to the second AP for communicating via the wireless channel based at least in part on the association identifier associated with the second AP; and
receive, based at least in part on transmitting the frame, a confirmation of the allocation of the portion of the transmission opportunity to the second AP.

2. The first AP of claim 1, wherein the at least one processor is further operable to cause the first AP to:
receive, via a backhaul link associated with a network controller that is associated with the first AP and the second AP, an indication that the association identifier is assigned to the second AP, wherein, to transmit the frame, the at least one processor is further operable to cause the first AP to:
transmit the frame based at least in part on the indication.

3. The first AP of claim 1, wherein the at least one processor is further operable to cause the first AP to:
select the association identifier associated with the second AP from a set of association identifiers specific to APs; and
transmit, based at least in part on the selecting, an indication that the association identifier is assigned to the second AP, wherein, to transmit the frame, the at least one processor is further operable to cause the first AP to:
transmit the frame based at least in part on the indication.

4. The first AP of claim 3, wherein the frame comprises an indication of a basic service set identifier associated with the first AP.

5. The first AP of claim 3, wherein the at least one processor is further operable to cause the first AP to:
store a mapping between association identifiers and APs, wherein, to select the association identifier; and
select the association identifier to be different from association identifiers associated with one or more other APs based at least in part on the mapping.

6. The first AP of claim 1, wherein the at least one processor is further operable to cause the first AP to:
receive, via a communication link between the first AP and the second AP, a first indication that the association identifier is associated with the second AP, wherein, to transmit the frame, the at least one processor is further operable to cause the first AP to:
transmit the frame based at least in part on the first indication.

7. The first AP of claim 6, wherein the at least one processor is further operable to cause the first AP to:
receive, via a communication link between the first AP and a third AP, a second indication of an association identifier associated with the third AP; and
transmit, via the communication link between the first AP and the third AP, a third indication to modify the association identifier associated with the third AP based at least in part on a match between the association identifier associated with the second AP and the association identifier associated with the third AP.

8. The first AP of claim 6, wherein the association identifier associated with the second AP is based at least in part on a basic service set color associated with the second AP, a basic service set identifier associated with the second AP, a compressed basic service set identifier associated with the second AP, or any combination thereof.

9. The first AP of claim 1, wherein the at least one processor is further operable to cause the first AP to:
transmit a second frame, the second frame being associated with triggering the second AP to request the allocation of the portion of the transmission opportunity; and
receive a response frame indicating that the second AP requests the allocation of the portion of the transmission opportunity, wherein, to transmit the frame, the at least one processor is further operable to cause the first AP to:
transmit the frame based at least in part on the response frame.

10. The first AP of claim 9, wherein the second frame is a buffer status report poll (BSRP) frame or a null data physical layer protocol data unit feedback report poll (NFRP) frame.

11. The first AP of claim 1, wherein:
the frame is a trigger frame comprising a multi-user request to send (MU-RTS) transmission opportunity sharing (TXS) frame, a buffer status report poll (BSRP) frame, or a null data physical layer protocol data unit feedback report poll (NFRP) frame, and
the association identifier associated with the second AP is included in an association identifier 12 (AID12) subfield of a user information field of the trigger frame.

12. A second access point (AP), comprising:
at least one memory; and
at least one processor communicatively coupled with the at least one memory, the at least one processor operable to cause the second AP to:
receive a frame from a first AP, the frame comprising an association identifier associated with the second AP, the frame allocating a portion of a transmission opportunity associated with communication via a wireless channel obtained by the first AP to the second AP based at least in part on the association identifier of the second AP;
transmit, based at least in part on receiving the frame, a confirmation of the allocation of the portion of the transmission opportunity to the second AP; and
transmit, based at least in part on the allocation of the portion of the transmission opportunity to the second AP, one or more frames during the portion of the transmission opportunity.

13. The second AP of claim 12, wherein the at least one processor is further operable to cause the second AP to:
receive, via a backhaul link associated with a network controller that is associated with the first AP and the second AP, an indication that the association identifier is assigned to the second AP, wherein, to receive the frame, the at least one processor is further operable to cause the second AP to:
receive the frame based at least in part on the indication.

14. The second AP of claim 12, wherein the at least one processor is further operable to cause the second AP to:
receive, via a communication link between the first AP and the second AP, an indication that the association identifier is assigned to the second AP, wherein, to receive the frame, the at least one processor is further operable to cause the second AP to:
receive the frame based at least in part on the indication.

15. The second AP of claim 14, wherein the frame comprises an indication of a basic service set identifier associated with the first AP.

16. The second AP of claim 14, wherein the at least one processor is further operable to cause the second AP to:
receive, via a communication link between the second AP and a third AP, a second indication that a second association identifier is assigned to the second AP;
receive a second frame from the third AP at the second AP, the second frame comprising the second association identifier associated with the second AP, the second frame allocating a portion of a second transmission opportunity associated with communication via the wireless channel obtained by the third AP to the second AP based at least in part on the second association identifier of the second AP; and
transmit, based at least in part on the allocation of the portion of the second transmission opportunity to the second AP, one or more frames during the portion of the second transmission opportunity.

17. The second AP of claim 12, wherein the at least one processor is further operable to cause the second AP to:
select the association identifier associated with the second AP from a set of association identifiers specific to APs; and
transmit, based at least in part on the selecting, an indication of the association identifier associated with the second AP to the first AP, wherein, to receive the frame, the at least one processor is further operable to cause the second AP to:
receive the frame based at least in part on the indication.

18. The second AP of claim 17, wherein the association identifier associated with the second AP is selected based at least in part on a basic service set color associated with the second AP, a basic service set identifier associated with the second AP, a compressed basic service set identifier associated with the second AP, or any combination thereof.

19. The second AP of claim 12, wherein the at least one processor is further operable to cause the second AP to:
receive a second frame, the second frame being associated with triggering the second AP to request the allocation of the portion of the transmission opportunity; and
transmit a response frame indicating that the second AP requests the allocation of the portion of the transmission opportunity, wherein, to receive the frame, the at least one processor is further operable to cause the second AP to:
receive the frame based at least in part on the response frame.

20. The second AP of claim 19, wherein the second frame is a buffer status report poll (BSRP) frame or a null data physical layer protocol data unit feedback report poll (NFRP) frame.

21. The second AP of claim 12, wherein the association identifier associated with the second AP is included in a set of association identifiers for identifying a respective AP, a set of association identifiers having a most significant bit of 1, a set of association identifiers associated with a high efficiency (HE) multi-user (MU) physical protocol data unit (PPDU), a set of association identifiers associated with an extremely high throughput (EHT) MU PPDU, or any combination thereof.

22. A method for wireless communications, comprising:
obtaining, at a first access point (AP), a transmission opportunity associated with communication via a wireless channel;
transmitting a frame comprising an association identifier associated with a second AP, the frame allocating a portion of the transmission opportunity to the second AP for communicating via the wireless channel based at least in part on the association identifier associated with the second AP; and
receiving, based at least in part on transmitting the frame, a confirmation of the allocation of the portion of the transmission opportunity to the second AP.

23. The method of claim 22, further comprising:
selecting the association identifier associated with the second AP from a set of association identifiers specific to APs; and
transmitting, based at least in part on the selecting, an indication that the association identifier is assigned to the second AP, wherein transmitting the frame comprises:
transmitting the frame based at least in part on the indication.

24. The method of claim 22, further comprising:
receiving, via a communication link between the first AP and the second AP, a first indication of a second association identifier associated with the second AP;
transmitting, via the communication link, a second indication that the second association identifier associated with the second AP matches an association identifier associated with a third AP; and
receiving, via the communication link based at least in part on the second indication, a third indication of the association identifier associated with the second AP.

25. The method of claim 22, further comprising:
transmitting a second frame, the second frame being associated with triggering a set of stations comprising the second AP to indicate whether a respective station requests the allocation of the portion of the transmission opportunity and to indicate a priority associated with traffic to be communicated during the portion of the transmission opportunity;
receiving a first response frame indicating that the second AP requests the allocation of the portion of the transmission opportunity and indicating a first priority associated with first traffic to be communicated during the portion of the transmission opportunity by the second AP;
receiving a second response frame indicating that a third AP requests the allocation of the portion of the transmission opportunity and indicating a second priority associated with second traffic to be communicated during the portion of the transmission opportunity by the third AP; and
selecting the second AP for allocation of the portion of the transmission opportunity based at least in part on the first priority being greater than the second priority, wherein the transmitting the frame comprises:
transmitting the frame based at least in part on the selecting.

26. The method of claim 22, wherein the association identifier associated with the second AP is included in a set of association identifiers for identifying a respective AP, a set of association identifiers having a most significant bit of 1, a set of association identifiers associated with a high efficiency (HE) multi-user (MU) physical protocol data unit (PPDU), a set of association identifiers associated with an extremely high throughput (EHT) MU PPDU, or any combination thereof.

27. A method for wireless communications, comprising:
receiving a frame from a first access point (AP) at a second AP, the frame comprising an association identifier associated with the second AP, the frame allocating a portion of a transmission opportunity associated with communication via a wireless channel obtained by the first AP to the second AP based at least in part on the association identifier of the second AP;
transmitting, based at least in part on receiving the frame, a confirmation of the allocation of the portion of the transmission opportunity to the second AP; and
transmitting, based at least in part on the allocation of the portion of the transmission opportunity to the second AP, one or more frames during the portion of the transmission opportunity.

28. The method of claim 27, further comprising:
transmitting, via a communication link between the first AP and the second AP, a first indication of a second association identifier associated with the second AP to the first AP;
receiving, via the communication link, a second indication that the second association identifier associated with the second AP matches an association identifier associated with a third AP;
selecting, based at least in part on the second indication, the association identifier for association with the second AP; and
transmitting, via the communication link based at least in part on the selecting, a third indication of the association identifier associated with the second AP.

29. The method of claim 27, further comprising:
receiving a second frame, the second frame being associated with triggering a set of stations comprising the second AP to indicate whether a respective station requests the allocation of the portion of the transmission opportunity and to indicate a priority associated with traffic to be communicated during the portion of the transmission opportunity; and
transmitting a first response frame indicating that the second AP requests the allocation of the portion of the transmission opportunity and indicating a first priority associated with first traffic to be communicated during the portion of the transmission opportunity by the second AP, wherein receiving the frame comprises:
receiving the frame based at least in part on the first priority being greater than a respective priority indicated by other APs of the set of stations.

30. The method of claim 27, wherein:
the frame is a trigger frame comprising a multi-user request to send (MU-RTS) transmission opportunity sharing (TXS) frame, a buffer status report poll (BSRP) frame, or a null data physical layer protocol data unit feedback report poll (NFRP) frame, and
the association identifier associated with the second AP is included in an association identifier 12 (AID12) subfield of a user information field of the trigger frame.
